(19) United States
(12) Patent Application Publication
(10) Pub. No.: US 2007/0296212 A1
(43) Pub. Date: Dec. 27, 2007

(54) Connector and Adapter Piece for Corrugated Pipes

(76) Inventor: Ernst Schwarz, Volketswil (CH)

Correspondence Address: NOTARO AND MICHALOS, 100 DUTCH HILL ROAD, SUITE 110, ORANGEBURG, NY, 10962-2100, US

(21) Appl. No.: 11/632,259

(22) PCT Filed: Jul. 4, 2005
(86) PCT No.: PCT/CH05/00372

§ 371 Date: Jan. 11, 2007

(30) Foreign Application Priority Data
Jul. 16, 2004 (CH) 1205/04

(51) Int. Cl. F16L 25/00

(52) U.S. Cl. 285/354

(57) ABSTRACT

The coupling piece 1 is formed as a two-component injection molded part of two housing parts. A first housing part 32 is comprised of a hard thermoplastic synthetic material and a second housing part 34 is comprised of a soft elastomer synthetic material. This second housing part 34 is directed toward an entry opening 5 on coupling piece 1, through which an end of a corrugated tubing is slid into the coupling piece 1. The second housing part 34 includes on the inside sealing elements 38, which seal the corrugated tubing. On the first housing part 32 are located resilient shell segments 20 with retaining elements 22, these retaining elements 22 engaging into the shell of the corrugated tubing end.

The invention relates to a connecting and coupling piece for corrugated tubings, with an injection-molded housing of synthetic material, which comprises a hollow core volume as well as an entry opening for receiving a corrugated tubing end as well as for the pass-through of cables, and a connecting flange as well as a connecting part.

Corrugated tubings or corrugated hoses are flexible elements, which are employed for example in the laying and protection of electrical and optical conductors in the construction industry or for the coupling of machines or other apparatus. An especially frequent application field is the use as flexible protection and guide tubing in the motor vehicle industry. In most cases the corrugated tubings are comprised of synthetic material; however, they may also be produced of metal. For the joining of corrugated tubings with one another and their coupling to apparatus, machines or devices, connection and coupling pieces are necessary, which are also referred to, for example, as fittings or screw-in sleeves.

Connecting and coupling pieces, or coupling fittings, of this type are known in various embodiments. For example CH 645 448 describes a coupling fitting for a flexible corrugated hose. This coupling fitting comprises a housing with a hollow core volume, wherein one end of the corrugated hose or corrugated tubing is slid into this hollow core volume. At the end facing away from the hollow core volume of the housing a connecting part in the form of a screw-in sleeve is located and at the rearward end of this screw-in sleeve the housing has a connecting flange. This screw-in sleeve serves for the purpose of connecting the fitting with a housing by screwing it into a threaded bore in a wall of this housing or the screw-in sleeve is inserted through a bore and clamped tight with a nut on the inside. The housing or casing of the fitting is produced through injection molding from a synthetic material, most often a thermoplastic material. Between the end of the corrugated tubing and the shell of the hollow core volume in the housing a sleeve gasket is placed. The latter prevents fluids and other foreign bodies from penetrating via the connecting site. This seal is either placed into the hollow core volume of the fitting housing before assembly or is slid over the end of the corrugated tubing and subsequently the corrugated tubing and the fittings are plugged together. The risk therein is that this seal is lost or, due to faulty insertion of the tubing end into the fittings, the seal becomes deformed and thereby its effect is impaired. Fix and securing the corrugated tubing end in the fitting housing takes place through a blocking element, which is inserted at right angles to the longitudinal axis through an opening in the housing. This blocking element can also be lost or fall out due to inadequate assembly. The blocking element can, furthermore, also be installed if the tubing end has not been completely inserted into the fitting up to the stop. In such a case the sealing is not or only partially engaged and the connection is not properly sealed. During the assembly the joining of several individual parts must be carried out correctly whereby a certain assembly expenditure is generated. Connecting and coupling pieces according to this example are especially suitable for connecting with corrugated tubings which are subject to high tear-out forces.

GB 2 107 814 discloses a further embodiment of a connection fitting for corrugated tubings. The connection fitting and the corrugated tubing are here comprised of an elastic material and consequently are both elastically deformable. In the connection fitting a hollow core volume is provided at whose shell surface encircling ribs are disposed corresponding to the ribs on the surface of the corrugated tubing. By plugging the corrugated tubing end together with the connection fitting these ribs on the shell surfaces engage one another and the end of the corrugated tubing, due to the elasticity of the materials, is held in the hollow core volume of the connection fittings and simultaneously sealed. This connection can be joined in simple manner, however, it can absorb only low tear-out forces in the longitudinal direction. It is therefore only suitable for low-load connections. There is in addition the risk that upon curving or bending over the corrugated tubing in the proximity of the connection the connection fitting is deformed and thereby openings are formed between the corrugated tubing surface and the hollow core volume, which break the sealing effect.

The goal of the invention is providing a connecting and coupling piece for corrugated tubings, in which no additional elements for sealing and for securing the connection are necessary, which securely holds the tubing end in the longitudinal direction even under high tear-out forces and in which the sealing between tubing end and housing is not broken even if the corrugated tubing is curved or bent over in the proximity of the connection and the sealing effect is ensured even if the tubing end is not completely inserted.

This goal is attained through the characteristics defined in the characterizing clause of patent claim 1. Advantageous further developments of the invention are evident based on the characteristics of the depending patent claims.

The connecting and coupling piece according to the invention is comprised of a housing with two housing parts which are integrally connected with one another as a two-component injection molded part. This implementation yields the advantage that different materials can be utilized and the individual regions of the housing or of the two housing parts can be adapted to different technical requirements. A first housing part with the connection flange is formed of a thermoplastic synthetic material and forms a hard housing part. A second housing part, which is substantially directed toward the entry opening for the corrugated tubing end, is comprised of a thermoplastic elastomeric synthetic material and forms an elastic housing part. Since the second housing part is comprised of an elastic material, it permits, on the one hand, the elastic or resilient deflection of subregions of the housing and, on the other hand, at least one region of the second housing part can be formed with sealing elements which are directed toward the hollow core volume. The connecting and coupling piece according to the invention can consequently absorb large forces with the first housing part and lends the connecting piece the desired strength. The second housing parts simultaneously makes possible the elastic or resilient deflection of subregions of the second or the first housing part, respectively, and generates the desired sealing between the housing and the end of the corrugated tubing. Additional elements on the first housing part, which engage into the second housing part, form reinforcement ribs for this second housing part. The flexibility or rigidity of the second housing part can be varied through different forms of these additional parts. Loose additional elements are not necessary in order to attain with the connecting and coupling fitting according to the invention high strength as well as also a strong sealing effect. Since the sealing elements are disposed in the hollow core volume directly following the entry opening, the connection between tubing end and fitting is already sealed even before the tubing end has been slid completely into the hollow core volume.

An advantageous development of the subject matter of the invention provides disposing on the first housing part at least two tongue-shaped shell segments extending in the direction of the longitudinal axis. These shell segments include on their free ends retaining elements which are directed approximately at right angles to the longitudinal axis and whose inner regions project into the hollow core volume. These shell segments with the retaining elements serve as securement elements for the tubing end which is slid into the hollow core volume. The end regions, which project into the hollow core volume, engage into the wave troughs on the shell of the corrugated tubing and thereby bring about increased tear-out strength of the connection between corrugated tubing and coupling piece. The tongue-shaped shell segments are at least partially encompassed by the elastic synthetic material of the second housing part and the end regions of the shell segments can therefore be moved approximately at right angles to the longitudinal axis of the housing, i.e. they can be moved radially resiliently. Since the movable tongue-shaped shell segments are connected completely and integrally with the elastic material of the second housing part, there is no opening in the housing and in the proximity of these shell segments the housing is also completely sealed. An especially high strength against tear-out forces which act on the corrugated tubing is attained if the free ends of the tongue-shaped shell segments are oriented in the direction of the longitudinal axis toward the connecting flange of the first housing part. With this disposition the end of the corrugated tubing can readily be slid into the hollow core volume of the housing. However, pulling it out is only possible under strong force action.

A further embodiment of the invention provides disposing grip elements at the free ends of the tongue-shaped shell segments, which elements are directed outwardly. These grip elements are formed such that they can be grasped with an auxiliary tool and the shell elements be pulled radially outwardly with the aid of this tool. Thereby the retaining elements can be released from the corrugated tubing. This permits the separation of the corrugated tubing and of the coupling piece with reduced pull-out forces and permits, if necessary, the facilitated disassembly of the connection.

It is also advantageous to form onto one radial face of the connecting flange directed toward the connecting part a sealing ring comprised of the thermoplastic elastomeric synthetic material of the second housing part. This sealing ring in this case replaces an additional seal to be emplaced, as is necessary with screw connections. In this embodiment the sealing ring is also integrally connected with the housing. Special advantages result if the connecting flange on the first housing part includes axial breakthroughs and these breakthroughs are also filled with the thermoplastic elastomeric synthetic material during the injection molding of the housing the two-component method. Thereby the sealing ring and the second housing part are connected with one another and all elements form an integral housing.

A useful implementation of the subject matter of the invention provides utilizing as the thermoplastic synthetic material for the first housing part a synthetic material from the group of polyamides (PA) or from the group of polypropylenes (PP). These materials have high strength and toughness and especially suitable for use in connecting and coupling pieces. As the thermoplastic elastomeric synthetic material of the second housing part have been found especially useful synthetic materials from the group of polyurethane elastomers (TPE-U) or the olefin elastomers (TPE-O) or the amide elastomers (TPE-A) or a cross-linked thermoplastic elastomer (TPE-X). These materials can be advantageously worked using the two-component injection molding method with the materials of the first housing part. This injection molding method is known per se.

The invention further proposes disposing the region with the sealing elements on the second housing part between the entry opening of the hollow core volume and the radial retaining elements on the shell segments of the first housing part. The sealing elements are here disposed about the entire circumference of the hollow core volume and form closed radial sealing elements. These sealing elements have the desired sealing function, however they permit simultaneously a tight clamping and retention of the corrugated tubing end in the hollow core volume of the housing. This disposition leads to an improved quality of the sealing function. The connection between corrugated tubing end and fitting is sealed even if the corrugated tubing end is not completely inserted into the fitting. The sealing effect is given even if only one rib of the corrugated tube engages into the retaining elements. Through the corresponding formation and selection of the dimensions of these sealing elements the desired sealing and holding force of the connection can be adapted over a wide range to different conditions of use.

A further embodiment of the invention provides disposing a rigid shell band about the entry opening of the hollow core volume, this shell band being connected via longitudinal ribs with the first housing part and is formed of the same thermoplastic synthetic material. This disposition yields the advantage that when curving or bending over the corrugated tubing in the proximity of the connection the elastic second housing part cannot be deformed. This ensures that the sealing effect between corrugated tubing and housing is not negatively affected.

With the connecting and coupling piece according to the invention consequently considerable advantages can be gained in simple manner. There are no loose parts which during the assembly of the connection can be lost or are unintentionally not included in the assembly. All necessary holding and sealing elements are located on the two housing parts of the integral housing and are fixedly connected therewith. The connection between tubing end and connecting and coupling piece is capable of absorbing large tear-out forces in the axial direction and is also resistant against bending-off of the corrugated tubing. The sealing effect between the end of the corrugated tubing and the hollow core volume at the connecting and coupling piece is retained even under high loading and difficult conditions of use, however, also if the tubing end is not completely inserted into the fitting. The assembly is considerably facilitated since the connection only needs to be plugged together and no additional parts are required.

In the following the invention will be explained in further detail in conjunction with embodiment examples with reference to the enclosed drawing. Therein depict:

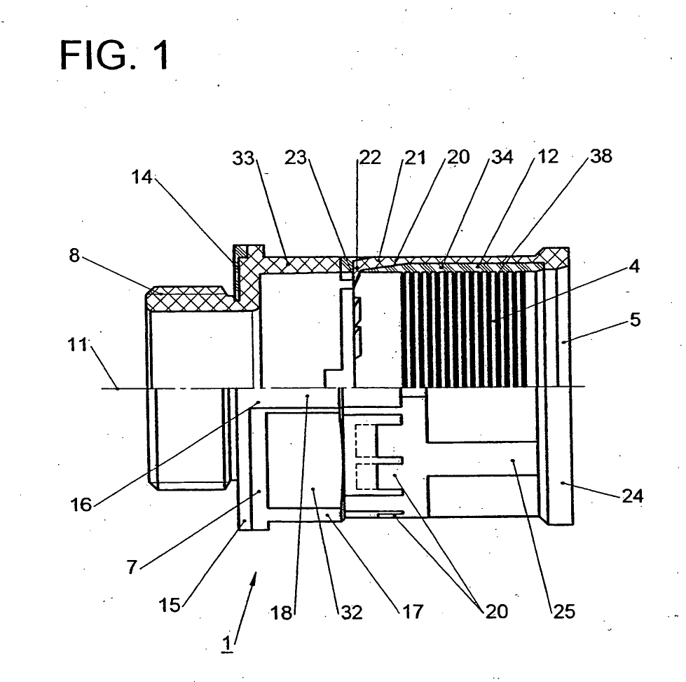

FIG. 1 a connecting and coupling piece according to the invention in side view with partial section,

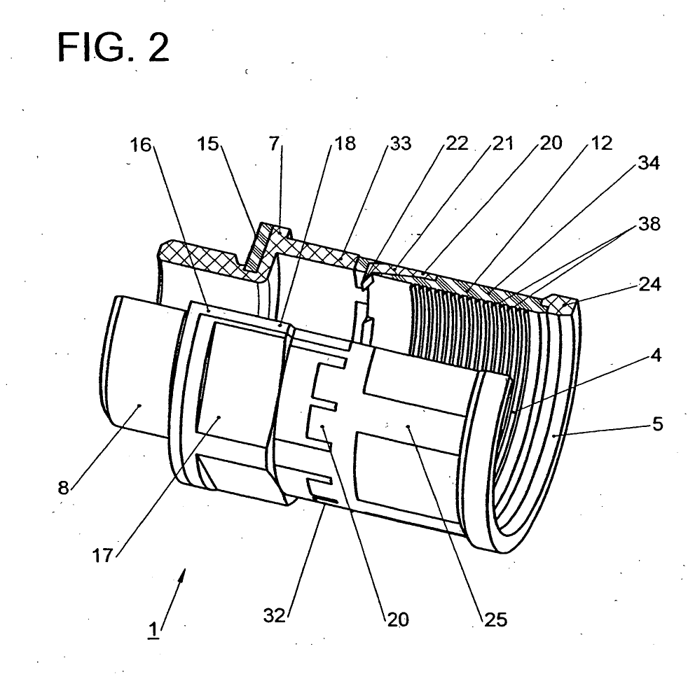

FIG. 2 the connecting and coupling piece according to FIG. 1 in perspective view,

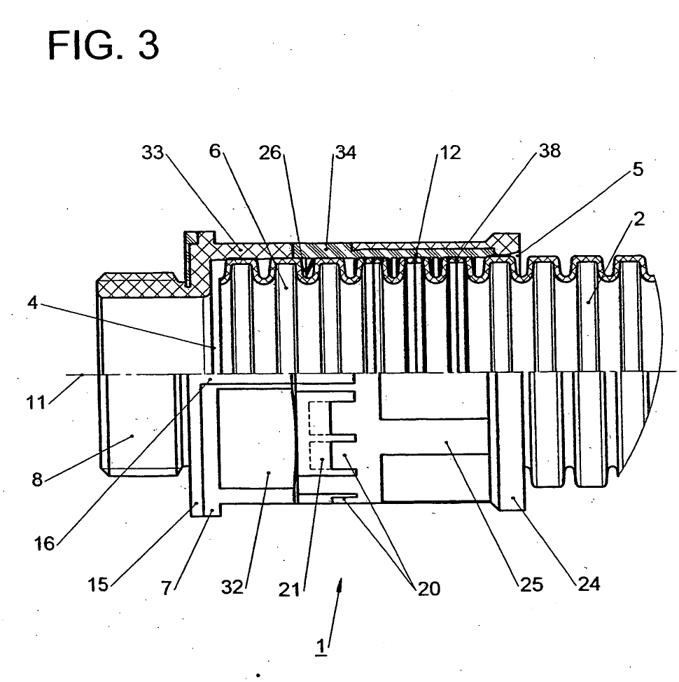

FIG. 3 the connecting and coupling piece according to FIG. 1 in connection with a corrugated tubing,

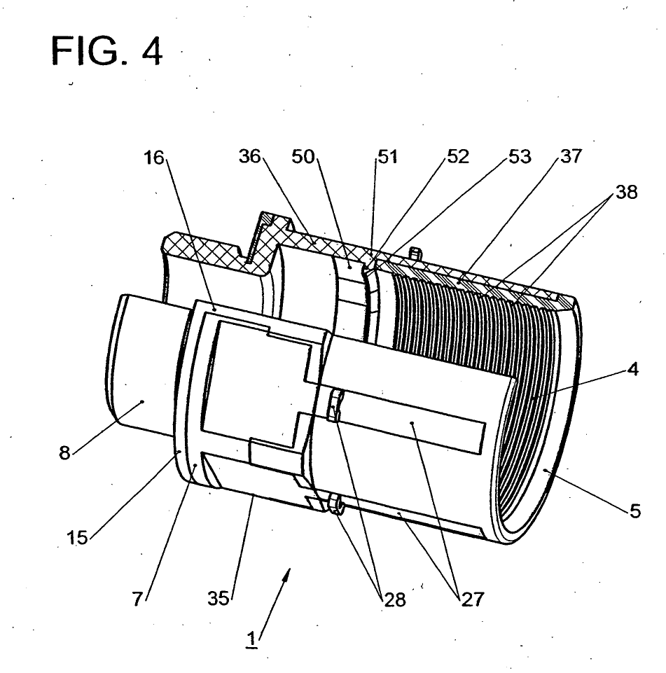

FIG. 4 a connecting and coupling piece according to the invention with a second embodiment of retaining elements, and

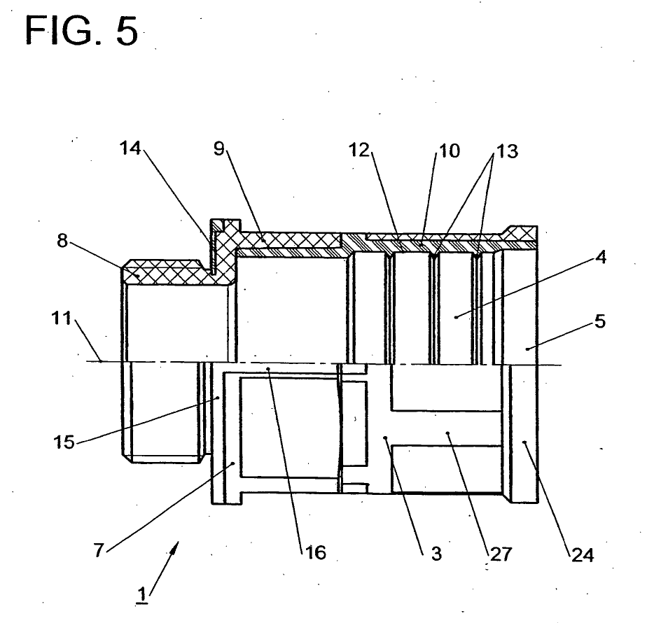

FIG. 5 a connecting and coupling piece for a dynamically loaded connection.

FIGS. 1, 2 and 3 show the same connecting and coupling piece 1 according to the invention. FIG. 1 is a side view with a partial longitudinal section, FIG. 2 a perspective view with a partial longitudinal section and FIG. 3 shows the connecting and coupling piece 1 in connection with a corrugated tubing 2. The coupling piece 1 is comprised of an injection molded housing 32, which includes a first housing part 33 and a second housing part 34. The first housing part 33 is comprised of a thermoplastic synthetic material, in the depicted example of a polyamide (PA). The second housing part 34 is comprised of a thermoplastic elastomeric synthetic material, in the depicted example of an amide elastomer (TPE-A). Both housing parts 33 and 34 are produced by means of a two-component injection molding method and after the injection molding form the integral injection molded housing 32.

The first housing part 33 comprises a connecting part 8 and connecting flange 7 adjoining the former and a shell piece 17. In the depicted example the connecting part 8 is comprised of a screw-in sleeve, however, it may also be formed by an angle piece, a bifurcation or another connecting part known per se. The shell piece 17 encompasses a portion of a hollow core volume 4 intended for receiving an end 6 of a corrugated tubing 2. The shell piece 17 includes at the end directed toward the corrugated tubing 2 additional parts in the form of a shell band 24 which is connected via longitudinal ribs 25 with the remaining regions of the shell piece 17. At the end directed toward the connecting flange 7 the shell piece 17 is formed so in a manner known per se that assembly tools can be brought into engagement. Between the connecting flange 7 and the shell band 24 the shell piece 17 is implemented grid-shaped and comprises at least two tongue-shaped shell segments 20. In the depicted example several pairwise groups of such shell segments 20 are available. The tongue-shaped shell segments 20 have free ends 21, which are oriented in the direction of the longitudinal axis 11 toward the connecting flange 7. At the free ends 21 the retaining elements 22 are formed, which are directed approximately at right angles to the longitudinal axis 11 and whose inner end regions 23 project into the hollow core volume 4. When the end 6 of the corrugated tubing 2 is inserted into the hollow core volume 4 these retaining elements 22 engage into a wave trough 26 on the shell of the corrugated tubing 2. When the corrugated tubing 2 is slid through the entry opening 5 into the hollow core volume 4, the retaining elements 22 can be deflected radially outwardly since the tongue-shaped shell segments 20 form spring elements.

Into the grid-shaped region of the first housing part 33 is injected the second housing part 34 and forms in this region also a grid-shaped housing structure. On this second housing part 34 is formed a region 12 which includes sealing elements 38 directed toward the hollow core volume 4. This region 12 and the sealing elements 38 extend substantially from the entry opening 5 of the hollow core volume 4 to the radial retaining elements 22. The sealing elements 38 are formed as ribs which have a smaller inner diameter than the outer diameter of the corrugated tubing 2. In the direction of the longitudinal axis 11 several such ribs are disposed successively, each rib extending completely about the entire circumference of the hollow core volume 4. In the depicted example at least ten such ribs are disposed spaced apart from one another which, together with the shell of the corrugated tubing 2, form a labyrinthine sealing. Since the second housing part 34 is comprised of an elastomer, the sealing elements 38 are also elastic and reinforce the sealing effect. The end 6 of the corrugated tubing 2 is simultaneously held in the hollow core volume 4 by the plurality of the sealing elements 38 and a relatively large pull-out force in the direction of the longitudinal axis 11 is already required in order to separate the tubing end 6 and the coupling piece 1 from one another. The sealing elements 38 are also effective even if the end 6 of the corrugated tubing 2 is not completely inserted into the hollow core volume 4. The full sealing effect is given even if the retaining elements 22 engage only into the front-most wave trough 26 on the corrugated tubing 2.

On the radial face 14 of the connecting flange 7 directed toward the connecting part 8 a sealing ring 15 is formed on. This sealing ring 15 is comprised of the same thermoplastic elastomeric material as the second housing part 34. In the connecting flange 7 is located at least one breakthrough 16 through which extends a web 18. This web 18 connects the sealing ring 15 with the second housing part 34. With the aid of this disposition the sealing ring 15 can be formed on simultaneously with the second housing part 34.

Since the first housing part 33 and the second housing part 34 together form the integral injection molded housing 32, the tongue-shaped shell segments 20 are at least partially encompassed by the elastic synthetic material of the second housing part 34. This ensures that the hollow core volume 4 is completely sealed off against the outside and the tongue-shaped shell segments 20 can simultaneously act as spring elements. By varying the geometric shape of the ribs 25 and of the grid structure of the first or the second housing part 33 or 34, respectively, the rigidity of the injection molded housing 32 can be varied in the region of the hollow core volume 4. In the depicted example the reinforcement ribs 25 and the shell band 24 are formed such that when the corrugated tubing 2 is bent in the proximity of the connection to the coupling part 1 no impermissible deformations of the coupling part 1 occur which could negatively affect the tightness of the connection. The embodiment depicted here is therefore especially suitable for the connection of corrugated tubings 2 with coupling fittings 1, which are subject to high tear-out forces and dynamic loading and simultaneously must have high tightness against the penetration of foreign substances.

FIG. 4 shows a second embodiment of the connecting and coupling piece 1 according to the invention, which includes an injection molded housing 35. This injection molded housing 35 is also formed integrally by the two-component injection molding of a first housing part 36 and a second housing part 37. In this embodiment the tongue-shaped shell segments 50 also extend in the direction of the longitudinal axis 11, the free ends 51 of the shell segments 50 being directed away from the connecting flange 7. At the free ends 51 of the tongue-shaped shell segments 50 retaining elements 52 with inner end regions 53 are here also disposed. These inner end regions 53 project into the hollow core volume 4 and, when sliding the end 6 of a corrugated tubing 2 in, snap into one of the wave troughs 26 on the shell of the corrugated tubing 2. The tongue-shaped shell segments 50 form spring elements, whereby the retaining elements 52 can be deflected in the radial direction. On the end of the first housing part 36 directed toward the entry opening 5 of the hollow core volume 4 are located reinforcement ribs 27 which reinforce the elastic region of the second housing part 37. In this embodiment lower push-in forces are necessary to slide the end 6 of the corrugated tubing 2 completely into the hollow core volume 4. This is the result of the fact that the portion of housing 35 directed toward the entry opening 5 can elastically adapt to the outer diameter of the corrugated tubing 2. This embodiment is normally not utilized for dynamically highly loaded connections. Nevertheless, it ensures in the normal application field a sufficient rigidity which also maintains and ensures the sealing effect between the sealing elements 38 and the shell of corrugated tubing 2. The sealing effect is also ensured in this embodiment if the tubing end 6 is not slid up to the stop into the hollow core volume 4. This embodiment of a coupling piece 1 can be produced somewhat more cost-effectively, yet it ensures high security against the tearing-out of the corrugated tubing 2 and simultaneous good sealing action. The remaining structural parts of the injection molded housing 35 are substantially formed identically to the embodiment example according to FIG. 1. These are in particular the connecting part 8, the connecting flange 7 and the formed-on sealing ring 15. The same materials are also utilized.

In the embodiment according to FIG. 4 the shell segments 50 include outwardly directed grip elements 28. These grip elements 28 are so formed that an auxiliary tool can be made to engage. They include, for example, bores into which the tips of a spreading tool can engage. With this tool the shell segments 50 can, if needed, be pulled radially outwardly. The retaining elements 52 are thereby released from the shell of the corrugated tubing 2 and their blocking action is nullified. This facilitates the separation of the corrugated tubing 2 from the coupling element 1 should this be necessary. Identical grip elements 25 can also be disposed on the shell segments 20 according to the embodiment of FIG. 1 to 3.

FIG. 5 shows a simpler embodiment of the connecting and coupling piece 1 according to the invention. An injection molded housing 3 is here also comprised of a first housing part 9 and a second housing part 10. The first hard housing part 9 is comprised of a thermoplastic synthetic material, preferably polyamide (PA), and the second housing part of an elastomer, preferably an amide elastomer (TPE-A). Both housing parts 9 and 10 are connected with one another by means of two-component injection molding methods and form the integral injection molded housing 3. The second housing part 10 includes a region 12 with sealing elements 13. However, in this embodiment these sealing elements 13 are formed such that, on the one hand, they ensure the sealing function against the shell of corrugated tubing 2 and, on the other hand, elastically engage with such strength into the wave troughs on the shell of corrugated tubing 2 that a sufficiently large retention force against the corrugated tubing 2 being torn out of the coupling piece 1 is generated. Since the wall thickness of the housing part 10 and also the selected thermoplastic elastomeric synthetic material can be varied, adaptations of the sealing effect and of the retention force to different operating conditions are possible. The first housing part 9 includes here also a connecting flange 7 and a connecting part 8. On the radial face 14 of the connecting flange 7 directed toward the connecting part 8 a sealing ring 15 is also formed on and via an axial breakthrough 16 connected with the second housing part 10. Impermissible or undesirable deformations of the second housing part 10 are prevented through additional parts of the first housing part 9, which engage into the second housing part. In the depicted example these additional parts are several axially directed reinforcement ribs 27 and a shell band 24. These additional parts can also have other geometric shapes, whereby the rigidity, or the elasticity, of the second housing part 10 can be varied over a wide range. In the depicted example the reinforcement ribs 27 act as radial springs and cooperate with the sealing elements 13. This embodiment example of an inventive connecting and coupling piece 1 can be produced especially cost-effectively and is suitable for connections with corrugated tubing 2 in which high tear-out forces in the direction of the longitudinal axis 11 do not occur.

In none of the three embodiment examples according to FIGS. 1 to 3, or 4 or 5, respectively, are additional assembly parts necessary. All of the necessary structural parts are disposed integrally on the injection molded housings 3, 32 or 35, respectively, whereby the connection of the corrugated tubing 2 with these coupling pieces 1 is simplified. Through the varied implementation within the scope of the described embodiment examples a wide range of applications for such connecting and coupling pieces 1 can be covered. The individual embodiments can be adapted to the occurring tear-out forces and the dynamic force actions, wherein in particular the embodiment according to FIGS. 1 to 3 offers high resistance against the tubing being torn out and a very good sealing effect. The sealing effect between corrugated tubing 2 and coupling piece 1 is attained in any event even if the end 6 of the corrugated tubing 2 is not completely slid or inserted into the coupling piece 1.

1-11. (canceled)

12: Connecting and coupling piece (1) for detachable connections with corrugated tubings (2), with an injecting molded housing (3; 32; 35) of a synthetic material, which comprises tubular shell undivided in the circumferential direction with a hollow core volume (4) as well as an entry opening (5) for inserting a corrugated tubing end (6) into the hollow core volume (4) as well as for guiding through cables, and a connecting flange (7) as well as a connecting part (8), characterized in that the undivided tubular housing (3; 32; 35) in the direction of the longitudinal axis (11) is comprised of two housing parts (9, 10; 33, 34; 36, 37) which are integrally connected with one another as a two-component injection molded part, wherein a first, hard housing part (9; 33; 36) with the connecting flange (7) is formed of a thermoplastic synthetic material and a second, elastic housing part (10; 34; 37), which is directed substantially toward the entry opening (5) for the corrugated tubing end (6), is comprised of a thermoplastic elastomeric synthetic material, additional parts of the first housing part (9; 33; 36) in the direction of the longitudinal axis (11) engage into the second housing part (10; 34; 37) and form reinforcement ribs (24, 25, 27) for this second housing part (10; 34; 37) and the second housing part (10; 34; 37) includes at least one region (12) with sealing elements (13) directed toward the hollow core volume (4).

13: Connecting and coupling piece for corrugated tubings as claimed in claim 12, characterized in that the first housing part includes at least two tongue-shaped shell segments (20; 50) extending in the direction of the longitudinal axis and these shell segments (20; 50) include at their free ends (21; 51) retaining elements (22; 52), which are directed approximately at right angles to the longitudinal axis (11) and whose inner end regions (23; 53) project into the hollow core volume (4).

14: Connecting and coupling piece for corrugated tubings as claimed in claim 12, characterized in that on a radial face (14) of the connecting flange (7) which is directed toward the connecting part (8),
a sealing ring (15) of the thermoplastic elastomeric synthetic material of the second housing part (10; 34; 37) is formed on.

15: Connecting and coupling piece for corrugated tubings as claimed in claim 12, characterized in that the thermoplastic synthetic material is a synthetic material from the group of polyamides (PA) or of polypropylenes (PP).

16: Connecting and coupling piece for corrugated tubings as claimed in claim 12, characterized in that the thermoplastic elastomeric synthetic material is a synthetic material from the group of polyurethane elastomers (TPE-U) or of the olefin elastomers (TPE-O) or of the amide elastomers (TPE-A) or is a cross-linked thermoplastic elastomer (TPE-X).

17: Connecting and coupling piece for corrugated tubings as claimed in claim 13, characterized in that the sealing elements (13; 38) on the second housing part (10; 34; 37) extend between the entry opening (5) of the hollow core volume (4) and the radial retaining elements (22; 52) on the shell segments (20; 50), wherein the sealing elements (13; 38) are disposed completely about the entire circumference of the hollow core volume (4).

18: Connecting and coupling piece for corrugated tubings as claimed in claim 12, characterized in that about the entry opening (5) a rigid shell band (24) is disposed and this shell band (24) is connected via longitudinal ribs (25) with the first housing part (33) and is formed of the same thermoplastic synthetic material.

19: Connecting and coupling piece for corrugated tubings as claimed in claim 13, characterized in that the tongue-shaped shell segments (20; 50) are at least partially encompassed by the elastic synthetic material of the second housing part (34; 37) and the free ends (21; 51) are resiliently movable in the radial direction.

20: Connecting and coupling piece for corrugated tubings as claimed in claim 14, characterized in that the connecting flange (7) on the first housing part (9; 33; 36) includes axial breakthroughs (16), these breakthroughs (16) are filled with thermoplastic elastomeric synthetic material and the sealing ring (15) and the second housing part (10; 34; 37) are integrally connected with one another.

21: Connecting and coupling piece for corrugated tubings as claimed in claim 13, characterized in that the free ends (21) of the tongue-shaped shell segments (20) are oriented in the direction of the longitudinal axis (11) toward the connecting flange (7) of the first housing part (33).

22: Connecting and coupling piece for corrugated tubings as claimed in claim 13, characterized in that on the free ends (21; 51) of the tongue-shaped shell segments (20; 50) outwardly directed grip elements (27) are disposed.
